(19) United States
(12) Patent Application Publication
(10) Pub. No.: US 2025/0242351 A1
(43) Pub. Date: Jul. 31, 2025

(54) GREEN, SAFE AND EFFICIENT MINING DEVICE FOR MINE

(71) Applicants: Huaneng Coal Technology Research Co., Ltd, Beijing (CN); Qingyang Xinzhuang Coal Industry Co., Ltd. Xinzhuang Coal Mine, Beijing (CN)

(72) Inventors: Quanchao ZHOU, Beijing (CN); Zhenyu LIU, Beijing (CN); Jun PAN, Beijing (CN); Youhui YIN, Beijing (CN); Junfeng CUI, Beijing (CN); Leiyu GU, Beijing (CN); Caiyun YIN, Beijing (CN); Jiaoyang HAO, Beijing (CN); Laihong FENG, Beijing (CN)

(73) Assignees: Huaneng Coal Technology Research Co., Ltd, Beijing (CN); Qingyang Xinzhuang Coal Industry Co., Ltd. Xinzhuang Coal Mine, Beijing (CN)

(21) Appl. No.: 18/635,050

(22) Filed: Apr. 15, 2024

(30) Foreign Application Priority Data
Jan. 26, 2024 (CN) 202410108681.7

(51) Int. Cl. B02C 1/04; B02C 23/12; B08B 15/02

(52) U.S. Cl. CPC B02C 1/04; B02C 23/12; B08B 15/02

(57) ABSTRACT

A green, safe and efficient mining device for a mine is provided. The device includes a support frame, a crushing bin, a fixed jaw plate, a movable jaw plate, a cam roller, a movable jaw back plate, first springs and a driving device. The support frame is provided with an opening, the crushing bin is installed on the support frame; the fixed jaw plate is vertically installed on a left side of an inside of the crushing bin, the movable jaw back plate is installed at one side of the movable jaw plate; a top end of the movable jaw plate is hinged to a right side of the crushing bin, the cam roller is rotatably connected with the inside of the crushing bin and is slidably connected with the movable jaw back plate.

### CROSS-REFERENCE TO THE RELATED APPLICATIONS

This application is based upon and claims priority to Chinese Patent Application No. 202410108681.7, filed on Jan. 26, 2024, the entire contents of which are incorporated herein by reference.

### TECHNICAL FIELD

The disclosure belongs to the technical field of mining equipment for mines, and in particular relates to a green, safe and efficient mining device for a mine.

### BACKGROUND

Open-pit coal mining is to remove the rocks and coverings covered on the coal seam, so that the coal is exposed to the surface for mining. The process of removing soil and rocks is called stripping, and the process of extracting coal is called coal mining. Open-pit coal mining usually divides the mine field into several horizontal layers, which are mined layer by layer from top to bottom, forming a ladder shape in space. This method has good working conditions and high safety, and it is a coal mining method that our country focuses on developing. In open-pit coal mining, crushing equipment will be used to crush coal blocks and stones.

When mining, it is necessary to use a crusher to crush the ore, thus crushing the ore into a small volume of fast particles. In the prior art, the jaw crusher is mostly used for ore crushing, the motor of the jaw crusher drives the belt and the belt pulley, and the movable jaw plate moves up and down through the eccentric shaft. When the movable jaw plate rises, the included angle between the elbow plate and the movable jaw plate becomes larger, thus pushing the movable jaw plate to approach the fixed jaw plate, and at the same time, the material is crushed or chopped to achieve the purpose of crushing. When the movable jaw plate descends, the included angle between the elbow plate and the movable jaw plate becomes smaller, and the movable jaw plate leaves the fixed jaw plate under the action of the pull rod and the first springs, and meanwhile, the crushed materials are discharged from the lower opening of the crushing cavity.

When the movable jaw plate is pushed close to the fixed jaw plate again, the movable jaw plate applies pressure and upward shearing force on the ore to be crushed, thereby crushing the ore. However, in the existing jaw crusher, the eccentric shaft driving the moving jaw plate is at the top end of the movable jaw plate, and the pressure direction of the moving jaw plate on the stone is perpendicular to the moving jaw plate, and the position of applying force is in the middle of the moving jaw plate. Therefore, it is urgent for those skilled in the field to put forward a crushing device for improving the supporting force of the back of the movable jaw plate, so as to realize the crushing efficiency of the ore.

### SUMMARY

In view of this, the disclosure provides a green, safe and efficient mining device for a mine, which is used to solve the above problems.

In order to achieve the above purpose, the disclosure adopts the following technical solutions.

A green, safe and efficient mining device for a mine includes a support frame, a crushing bin, a fixed jaw plate, a movable jaw plate, a cam roller, a movable jaw back plate, first springs and a driving device. The support frame is provided with an opening, the crushing bin is installed on the support frame and located above the opening. The fixed jaw plate is vertically installed on a left side of an inside of the crushing bin, the movable jaw back plate is installed at one side of the movable jaw plate. A top end of the movable jaw plate is hinged to a right side of the crushing bin, the cam roller is rotatably connected with the inside of the crushing bin and is slidably connected with the movable jaw back plate. A pair of the first springs are located at both sides of a bottom end of the movable jaw plate, ends of the first springs are fixedly connected with the movable jaw plate, and other ends of the first springs are fixedly connected with the inside of the crushing bin, the driving device is in transmission connection with the cam roller.

In some embodiments, the green, safe and efficient mining device for a mine further includes a screening device. The screening device includes a sieve plate, second springs and a sieve plate shaft, the sieve plate shaft is fixedly connected with an end of the sieve plate, two ends of the sieve plate shaft pass through the crushing bin and are rotatably connected with the crushing bin. A pair of the second springs are located at both sides of the sieve plate, and ends of the second springs are fixedly connected with a bottom end of the fixed jaw plate, and other ends of the second springs are fixedly connected with the sieve plate.

In some embodiments, the driving device includes a motor, a first belt, a first belt pulley and a second belt pulley, an outer side wall of the crushing bin is provided with a motor bracket, and the motor is installed on the motor bracket. The first belt pulley is installed at an output end of the motor, the second belt pulley is installed on the cam roller, and both the first belt pulley and the second belt pulley are in transmission connection with the first belt.

In some embodiments, the driving device further includes a second belt, a third belt pulley, a fourth belt pulley, a first gear and a tooth-missing gear, the third belt pulley and the second belt pulley are installed on the cam roller side by side, the fourth belt pulley is rotatably connected to an side wall of the crushing bin, and both the third belt pulley and the fourth belt pulley are in transmission connection with the second belt. The tooth-missing gear is fixedly installed on a wheel axle of the fourth belt pulley, the first gear is fixedly installed on the sieve plate shaft, and the tooth-missing gear is meshed with the first gear for transmission.

In some embodiments, the green, safe and efficient mining device for a mine further includes a dust removal device, the dust removal device includes a dust removal cover, and the dust removal cover is installed at a top end of the crushing bin and above the fixed jaw plate and the movable jaw plate.

In some embodiments, a dust removal curtain is arranged in the dust removal cover.

In some embodiments, the dust removal device further includes a cyclone separation device, the side wall of the crushing bin is provided with a dust removal opening, and the cyclone separation device is communicated with the dust removal opening.

In some embodiments, a back of the fixed jaw plate is provided with reinforcing brackets.

The beneficial effects of the embodiments are as follows:

The driving device in the disclosure drives the cam roller to rotate clockwise in the crushing bin, and the cam roller applies force on the movable jaw back plate during the rotation process, and the movable jaw back plate applies force on the whole back of the movable jaw plate, so that the movable jaw plate presses the ore between the movable jaw plate and the fixed jaw plate to generate pressure on the ore. Because the movable jaw plate rotates around its top end at the same time, the shear force relative to the fixed jaw plate is generated on the ore simultaneously. Further, with the repeated rotation of the cam roller and the periodic pulling of the bottom end of the movable jaw plate by the first springs, the movable jaw plate will vibrate; and the pressure, shear force and vibration of the movable jaw plate on the ore will jointly improve the crushing efficiency of the ore. The crushed ore falls onto the sieve plate, and the smaller volume ore passes through the sieve plate, while the larger volume ore stays on the sieve plate. When the gravity of the accumulated ore is greater than the pulling force of the second springs on the left end of the sieve plate, the larger volume ore rolls outside of the crushing bin to wait for re-crushing, and the screening device ensures the quality of ore crushing. The driving motor drives the cam roller to rotate in the crushing bin through the first belt, the first belt pulley and the second belt pulley. The second belt pulley and the third belt pulley are fixed on the cam roller meanwhile, and the motor drives the tooth-missing gear to rotate through the third belt pulley, the second belt and the fourth belt pulley simultaneously, and the tooth-missing gear is periodically meshed with the first gear to drive the sieve plate to be periodically opened, thereby discharging the larger volume ore. The cyclone separation device avoids using water to eliminate the dust generated when the ore is crushed, which makes the device more green and environmentally friendly.

### BRIEF DESCRIPTION OF THE DRAWINGS

In order to more clearly explain the technical scheme in the embodiment of the disclosure or the prior art, the drawings needed in the description of the embodiment or the prior art will be briefly introduced below. Apparently, the drawings in the following description are only embodiments of the disclosure. For those of ordinary skill in the art, other drawings can be obtained according to the provided drawings without creative efforts.

FIG. 1 is an internal structural diagram of a green, safe and efficient mining device for a mine;

FIG. 2 is a front view of the green, safe and efficient mining device for a mine;

FIG. 3 is a top view of the green, safe and efficient mining device for a mine, and

FIG. 4 is a schematic structural diagram of the cam roller.

List of reference characters: 10 support frame; 11 opening; 12 dust removal opening; 20 crushing bin; 21 motor bracket; 30 fixed jaw plate; 31 reinforcing bracket; 40 movable jaw plate; 50 cam roller; 60 movable jaw back plate; 70 first spring; 81 motor; 82 first belt; 83 first belt pulley; 84 second belt pulley; 85 second belt; 86 third belt pulley; 87 fourth belt pulley; 88 first gear; 89 tooth-missing gear; 91 sieve plate; 92 second spring; 93 sieve plate shaft; 101 dust removal cover; 102 dust removal curtain; and 103 cyclone separation device.

### DETAILED DESCRIPTION OF THE EMBODIMENTS

In the following, the technical scheme in the embodiment of the disclosure will be clearly and completely described in combination with the attached drawings in the embodiment of the disclosure. Apparently, the described embodiment is only a part of the embodiment of the disclosure, but not all of the embodiment. Based on the embodiments in the disclosure, all other embodiments obtained by those of ordinary skill in the art without creative efforts belong to the scope of protection in the disclosure.

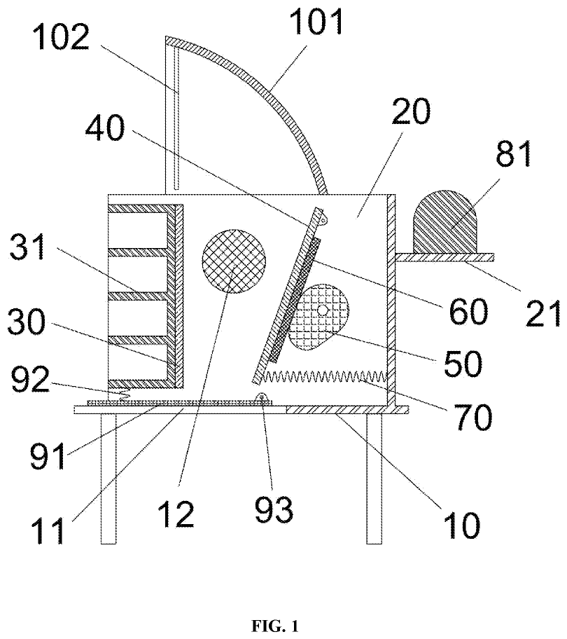

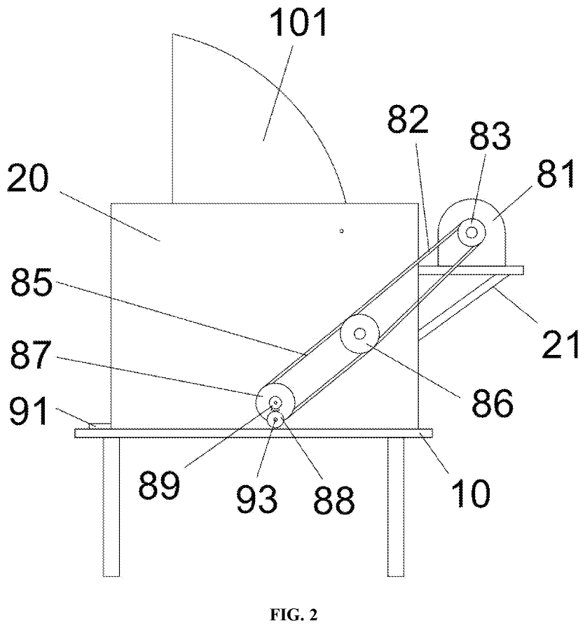

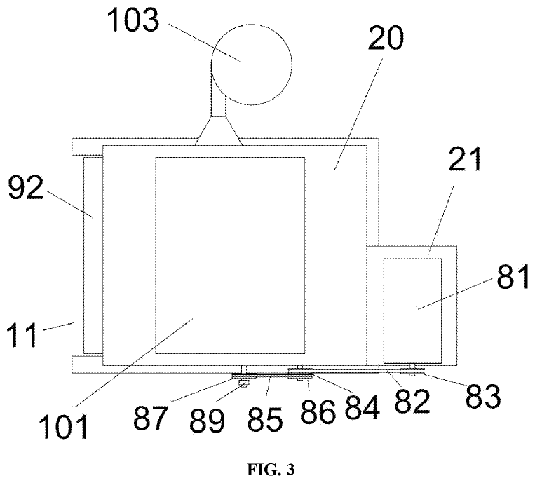

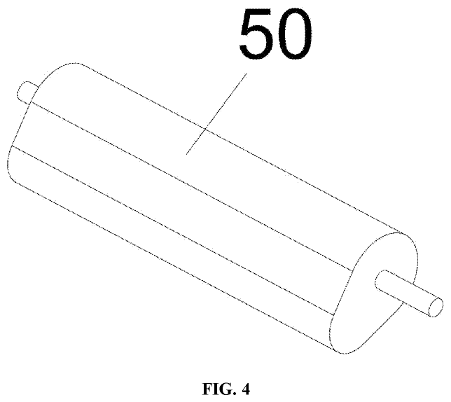

Referring to FIGS. 1-4, a green, safe and efficient mining device for a mine is provided, which includes a support frame 10, a crushing bin 20, a fixed jaw plate 30, a movable jaw plate 40, a cam roller 50, a movable jaw back plate 60, first springs 70 and a driving device. The support frame 10 is provided with an opening 11, the crushing bin 20 is installed on the support frame 10 and located above the opening 11. The fixed jaw plate 30 is vertically installed on a left side of an inside of the crushing bin 20, the movable jaw back plate 60 is installed at one side of the movable jaw plate 40. A top end of the movable jaw plate 40 is hinged to a right side of the crushing bin 20, the cam roller 50 is rotatably connected with the inside of the crushing bin 20 and is slidably connected with the movable jaw back plate 60. A pair of the first springs 70 are located at both sides of a bottom end of the movable jaw plate 40, ends of the first springs 70 are fixedly connected with the movable jaw plate 40, and other ends of the first springs 70 are fixedly connected with the inside of the crushing bin 20, the driving device is in transmission connection with the cam roller 50.

The driving device drives the cam roller 50 to rotate clockwise in the crushing bin 20, and the cam roller 50 applies force on the movable jaw back plate 60 during the rotation process, and the movable jaw back plate 60 applies force on the whole back of the movable jaw plate 40, so that the movable jaw plate 40 presses the ore between the movable jaw plate 40 and the fixed jaw plate 30 to generate pressure on the ore. Because the movable jaw plate 40 rotates around its top end at the same time, the shear force relative to the fixed jaw plate 30 is generated on the ore simultaneously. Further, with the repeated rotation of the cam roller 50 and the periodic pulling of the bottom end of the movable jaw plate 40 by the first springs 70, the movable jaw plate 40 will vibrate; and the pressure, shear force and vibration of the movable jaw plate 40 on the ore will jointly improve the crushing efficiency of the ore.

In an embodiment, the green, safe and efficient mining device for a mine further includes a screening device. The screening device includes a sieve plate 91, second springs 92 and a sieve plate shaft 93, the sieve plate shaft 93 is fixedly connected with an end of the sieve plate 91, two ends of the sieve plate shaft 93 pass through the crushing bin 20 and are rotatably connected with the crushing bin 20; a pair of the second springs 92 are located at both sides of the sieve plate 91, and ends of the second springs 92 are fixedly connected with a bottom end of the fixed jaw plate 30, and other ends of the second springs 92 are fixedly connected with the sieve plate 91.

The crushed ore falls onto the sieve plate 91, and the smaller volume ore passes through the sieve plate 91, while the larger volume ore stays on the sieve plate 91. When the gravity of the accumulated ore is greater than the pulling force of the second springs 92 on the left end of the sieve plate 91, the larger volume ore rolls outside of the crushing bin 20 to wait for re-crushing, and the screening device ensures the quality of ore crushing.

In an embodiment, the driving device includes a motor 81, a first belt 82, a first belt pulley 83 and a second belt pulley 84, an outer side wall of the crushing bin 20 is provided with a motor bracket 21, and the motor 81 is installed on the motor bracket 21; the first belt pulley 83 is installed at an output end of the motor 81, the second belt pulley 84 is installed on the cam roller 50, and both the first belt pulley 83 and the second belt pulley 84 are in transmission connection with the first belt 82. The driving motor 81 drives the cam roller 50 to rotate in the crushing bin 20 through the first belt 82, the first belt pulley 83 and the second belt pulley 84.

In an embodiment, the driving device further includes a second belt 85, a third belt pulley 86, a fourth belt pulley 87, a first gear 88 and a tooth-missing gear 89, the third belt pulley 86 and the second belt pulley 84 are installed on the cam roller 50 side by side, the fourth belt pulley 87 is rotatably connected to an side wall of the crushing bin 20, and both the third belt pulley 86 and the fourth belt pulley 87 are in transmission connection with the second belt 85. The tooth-missing gear 89 is fixedly installed on a wheel axle of the fourth belt pulley 87, the first gear 88 is fixedly installed on the sieve plate shaft 93, and the tooth-missing gear 89 is meshed with the first gear 88 for transmission. The second belt pulley 84 and the third belt pulley 86 are fixed on the cam roller 50 meanwhile, and the motor 81 drives the tooth-missing gear 89 to rotate through the third belt pulley 86, the second belt 85 and the fourth belt pulley 87 simultaneously, and the tooth-missing gear 89 is periodically meshed with the first gear 88 to drive the sieve plate 91 to be periodically opened, thereby discharging the larger volume ore.

In an embodiment, the green, safe and efficient mining device for a mine further includes a dust removal device. The dust removal device includes a dust removal cover 101, and the dust removal cover 101 is installed at a top end of the crushing bin 20 and above the fixed jaw plate 30 and the movable jaw plate 40. The dust removal cover 101 prevents dust generated when ore is crushed from entering the air and polluting the environment.

In an embodiment, a dust removal curtain 102 is arranged in the dust removal cover 101. The dust removal curtain 102 can further prevent the dust in the dust removal cover 101 from overflowing.

In an embodiment, the dust removal device further includes a cyclone separation device 103, the side wall of the crushing bin 20 is provided with a dust removal opening 12, and the cyclone separation device 103 is communicated with the dust removal opening 12. The cyclone separation device 103 avoids using water to eliminate the dust generated when the ore is crushed, which makes the device more green and environmentally friendly.

In an embodiment, a back of the fixed jaw plate 30 is provided with reinforcing brackets 31. The reinforcing brackets 31 can improve the structural strength of the fixed jaw plate 30.

Each embodiment in this specification is described in a progressive way, and each embodiment focuses on the differences from other embodiments, so the same and similar parts between embodiments can be referred to each other. As for the device disclosed in the embodiment, because it corresponds to the method disclosed in the embodiment, the description is relatively simple, and the relevant points can only refer to the description in the method section.

The foregoing description of the disclosed embodiments enables those skilled in the art to make or use the disclosure. Many amendments to these embodiments will be apparent to those skilled in the art, and the general principles defined herein can be implemented in other embodiments without departing from the spirit or scope of the disclosure. Therefore, the disclosure is not to be limited to the embodiments shown herein, but is to be accorded the widest scope consistent with the principles and novel features disclosed herein.

What is claimed is:

1. A green, safe and efficient mining device for a mine, comprising a support frame, a crushing bin, a fixed jaw plate, a movable jaw plate, a cam roller, a movable jaw back plate, a pair of first springs and a driving device, wherein the support frame is provided with an opening, the crushing bin is installed on the support frame and located above the opening;
the fixed jaw plate is vertically installed on a left side of an inside of the crushing bin, the movable jaw back plate is installed at one side of the movable jaw plate;
a top end of the movable jaw plate is hinged to a right side of the crushing bin, the cam roller is rotatably connected with the inside of the crushing bin and is slidably connected with the movable jaw back plate; and
the pair of first springs are located at both sides of a bottom end of the movable jaw plate, first ends of the pair of first springs are fixedly connected with the movable jaw plate, and second ends of the pair of first springs are fixedly connected with the inside of the crushing bin, the driving device is in transmission connection with the cam roller.

2. The green, safe and efficient mining device for the mine according to claim 1, further comprising a screening device, wherein the screening device comprises a sieve plate, a pair of second springs and a sieve plate shaft, the sieve plate shaft is fixedly connected with an end of the sieve plate, two ends of the sieve plate shaft pass through the crushing bin and are rotatably connected with the crushing bin; and
the pair of second springs are located at both sides of the sieve plate, and first ends of the pair of second springs are fixedly connected with a bottom end of the fixed jaw plate, and second ends of the pair of second springs are fixedly connected with the sieve plate.

3. The green, safe and efficient mining device for the mine according to claim 2, wherein the driving device comprises a motor, a first belt, a first belt pulley and a second belt pulley, an outer side wall of the crushing bin is provided with a motor bracket, and the motor is installed on the motor bracket; and
the first belt pulley is installed at an output end of the motor, the second belt pulley is installed on the cam roller, and both the first belt pulley and the second belt pulley are in transmission connection with the first belt.

4. The green, safe and efficient mining device for the mine according to claim 3, wherein the driving device further comprises a second belt, a third belt pulley, a fourth belt pulley, a first gear and a tooth-missing gear, the third belt pulley and the second belt pulley are installed on the cam roller side by side, the fourth belt pulley is rotatably connected to an side wall of the crushing bin, and both the third belt pulley and the fourth belt pulley are in transmission connection with the second belt; and
the tooth-missing gear is fixedly installed on a wheel axle of the fourth belt pulley, the first gear is fixedly installed on the sieve plate shaft, and the tooth-missing gear is meshed with the first gear for transmission.

5. The green, safe and efficient mining device for the mine according to claim 1, further comprising a dust removal device, wherein the dust removal device comprises a dust removal cover, and the dust removal cover is installed at a top end of the crushing bin and above the fixed jaw plate and the movable jaw plate.

6. The green, safe and efficient mining device for the mine according to claim 5, wherein a dust removal curtain is arranged in the dust removal cover.

7. The green, safe and efficient mining device for the mine according to claim 5, wherein the dust removal device further comprises a cyclone separation device, a side wall of the crushing bin is provided with a dust removal opening, and the cyclone separation device is communicated with the dust removal opening.

8. The green, safe and efficient mining device for the mine according to claim 1, wherein a back of the fixed jaw plate is provided with reinforcing brackets.
